(19) United States
(12) Patent Application Publication
(10) Pub. No.: US 2003/0234869 A1
(43) Pub. Date: Dec. 25, 2003

(54) Camera for measuring distance to object

(75) Inventors: Chih-Hui Chen, Taichung (TW); Lung-Pin Chung, Taichung (TW); Hua-Tang Liu, Taichung (TW); Te-Wei Liu, Taichung (TW); Jui-Feng Huang, Taichung (TW); Chin-Wei Hung, Taichung (TW); Chih-Hsiang Lin, Taichung (TW); Hsin-Feng Lee, Taichung (TW); Charles Liou, Taichung (TW); Pie-Yau Chien, Taichung (TW)

Correspondence Address: Richard L. Byrne, 700 Koppers Building, 436 Seventh Avenue, Pittsburgh, PA, 15219-1818, US

(73) Assignee: Asian Optical Co., Inc.

(21) Appl. No.: 10/177,006

(22) Filed: Jun. 21, 2002

(51) Int. Cl. H04N 5/225

(52) U.S. Cl. 348/207.99

(57) ABSTRACT

A camera for measuring the distance to an object is combined with a laser range measuring device by using a beam splitting device so as to simultaneously take the image of the object and measure the distance between the camera and the object. Using the focal length of the lens, the width and height of the image on the image detector, and the distance between the camera and the object, it is then possible to compute the width and height of the object according to the geometrical optics. By means of obtaining the speed of the image moving on the image detector, the camera of the invention further computes the speed of the object which is projected on a plane perpendicular to the optical axis of the lens.

### BACKGROUND OF THE INVENTION

1. Field of Invention

The invention relates to a camera for measuring the distance to an object and, in particular, to a camera that incorporates a laser range-measuring device.

2. Related Art

The conventional digital camera has a CCD (Charge-Coupled Device) and a lens. An object forms an image on the CCD through the lens.

The conventional digital camera, however, can only be used to take images but is unable to measure the distance between the digital camera and the object.

### SUMMARY OF THE INVENTION

In view of the foregoing, it is an objective of the invention to provide a camera for measuring the distance to an object. It includes a camera body and a laser range-measuring device, with which the distance to the object is measured.

Pursuant to the above objective, the disclosed camera includes a lens, a beam splitting device, an image detector, a microprocessor, a display, and a laser range-measuring device. The laser range-measuring device uses the beam splitting device and the lens to obtain the distance to the object. Furthermore, using the focal length, the width and height of the image on the image detector, and the distance between the camera and the object, the invention can compute the width and height of the object according to the geometrical optics.

The invention is featured in the combination of the beam splitting device that makes the combination of the camera and the laser range-measuring device possible.

The invention is also featured in that it can compute the width and height of the object according to the geometrical optics with the help of the distance to the object measured by the laser range-measuring device.

According to the above-mentioned features, the invention can further obtain the moving speed of the object.

One advantage of the invention is that the distance between the camera and an object can be obtained along with the object's image at the same time.

Another advantage of the invention is that the width and height of the object can be obtained according to the geometrical optics and, therefore, the moving speed of the object can be computed.

### BRIEF DESCRIPTION OF THE DRAWINGS

The invention will become more fully understood from the detailed description given hereinbelow illustration only, and thus are not limitative of the present invention, and wherein:

FIG. 1 schematically shows the disclosed digital camera;

FIG. 2 is a flowchart which schematically demonstrates how the microprocessor computes the distance between the camera and an object;

FIGS. 3A through 3C schematically show how the disclosed digital camera can be used to measure the size of the object on a plane perpendicular to the optical axis of the lens; and

FIGS. 4A to 4C are a series of diagrams illustrating the relation between the image moving speed and the object moving speed.

### DETAILED DESCRIPTION OF THE INVENTION

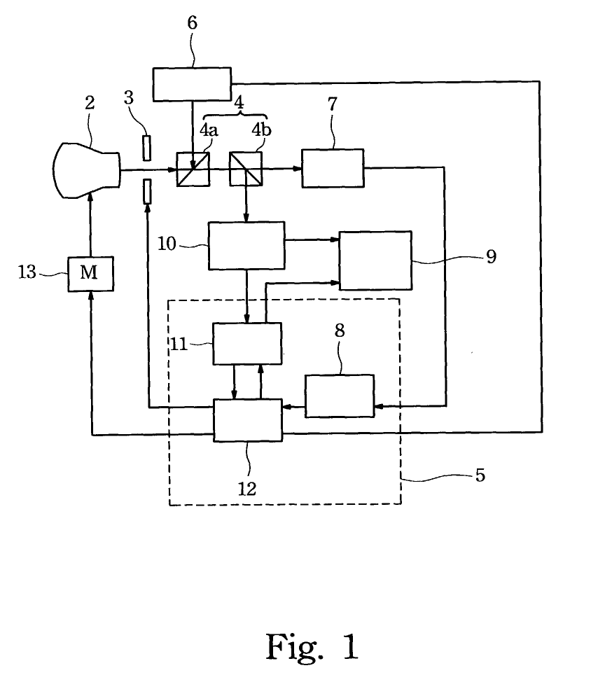

With reference to FIG. 1, the disclosed digital camera includes a zoom lens 2, an image detector 10, a microprocessor 5, a beam splitting device 4, a light emitter 6, and a light receiver 7. The beam splitting device 4 includes a first beam splitter 4a and a second beam splitter 4b. The microprocessor 5 includes an image processor 11, a range signal processor 8 and a CPU (Central Processing Unit) 12.

As shown in the drawing, the light emitter 6, such as a semiconductor light emitter, is controlled by the CPU 12 to send out a single-wavelength beam. This single-wavelength beam is reflected by the first beam splitter 4a and projected by the zoom lens 2 on an object (not shown). The object then reflects the single-wavelength beam through the zoom lens 2, the first beam splitter 4a and the second beam splitter 4b. The light signal is finally received by the light receiver 7, e.g. an avalanche photodiode receiver. The light receiver converts the single-wavelength beam into an electric signal, which is then sent to the microprocessor 5. In the microprocessor 5 the range signal processor 8 filters out noisy diffusive light. The extracted light signal is then used by the CPU 12 to compute the distance between the camera and the object.

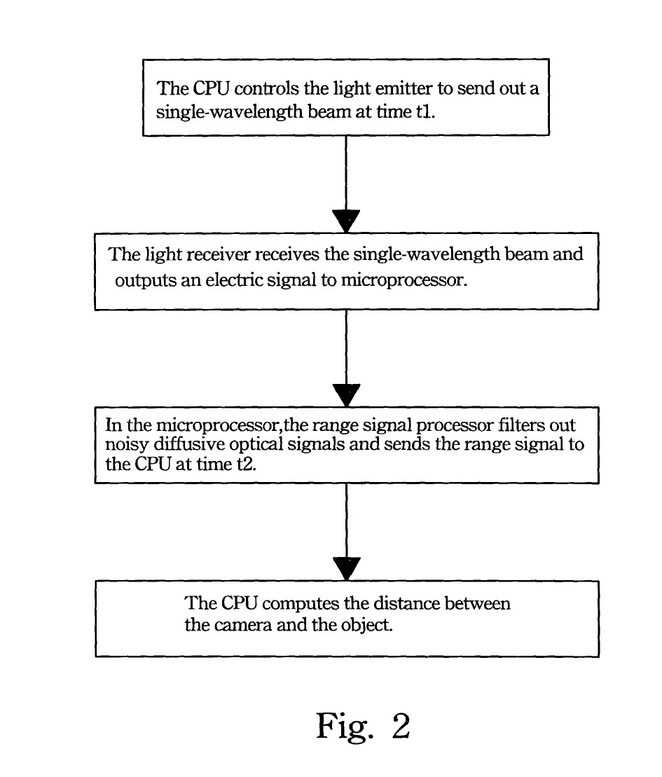

FIG. 2 schematically demonstrates how the microprocessor computes the distance between the camera and the object. In step 1, the CPU makes the light emitter to send out a single-wavelength beam at time t1. In step 2, the light receiver receives the single-wavelength beam and converts it into an electric signal for the microprocessor to use. The single-wavelength beam includes that reflected from the object and those produced by other objects in the external environment. Therefore, the electric signal at the moment contains the range signal from the object and noisy diffusive light signals. In step 3, the range signal processor is employed to filter out the noisy diffusive signals and sends the range signal produced at time t2 to the CPU. In step 4, the CPU computes the distance D between the camera and the object using the formula D=C×(t2−t1)/2, where C is the speed of light.

With further reference to FIG. 1, after the CPU 12 obtains the distance between the camera and the object, the distance is shown on an image display 9, such as an LCD (Liquid Crystal Display), via the image processor 11. In addition, the image of the object is formed on the image detector 10, e.g. a CCD , with the help of the zoom lens 2. The light passing through the zoom lens 2 is reflected by the second beam splitter 4b and forms an image on the image detector 10. The image detector converts the image into an image signal, which is directly sent to the image display 9 or first to the image processor 11 and then the image display 9.

The disclosed digital camera further contains a motor 13 and an adjustable aperture 3. The microprocessor 5 controls the motor 13 to adjust the focal length of the zoom lens 2 and the adjustable aperture to change the exposure.

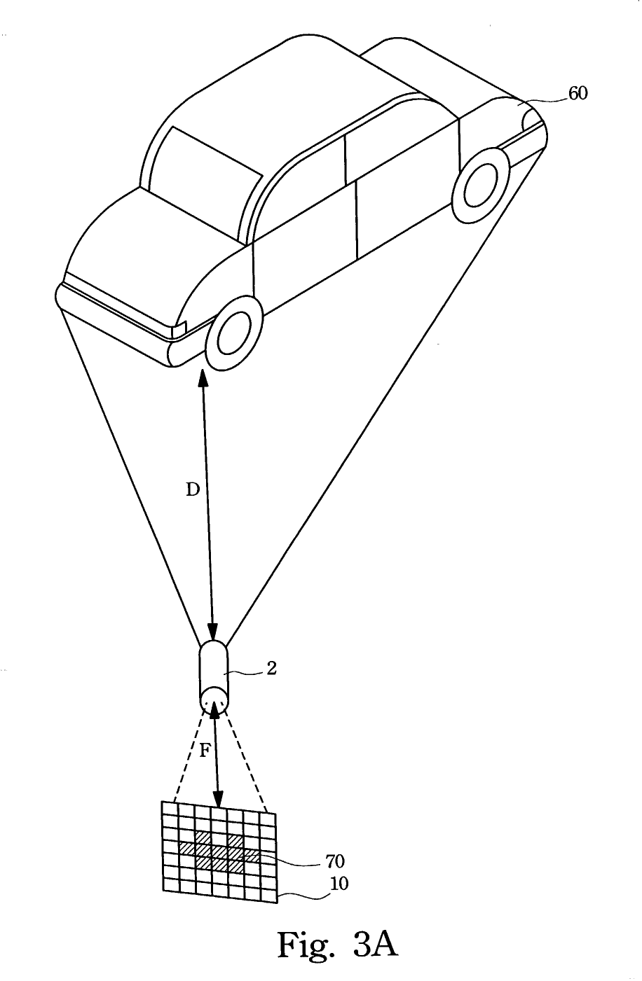

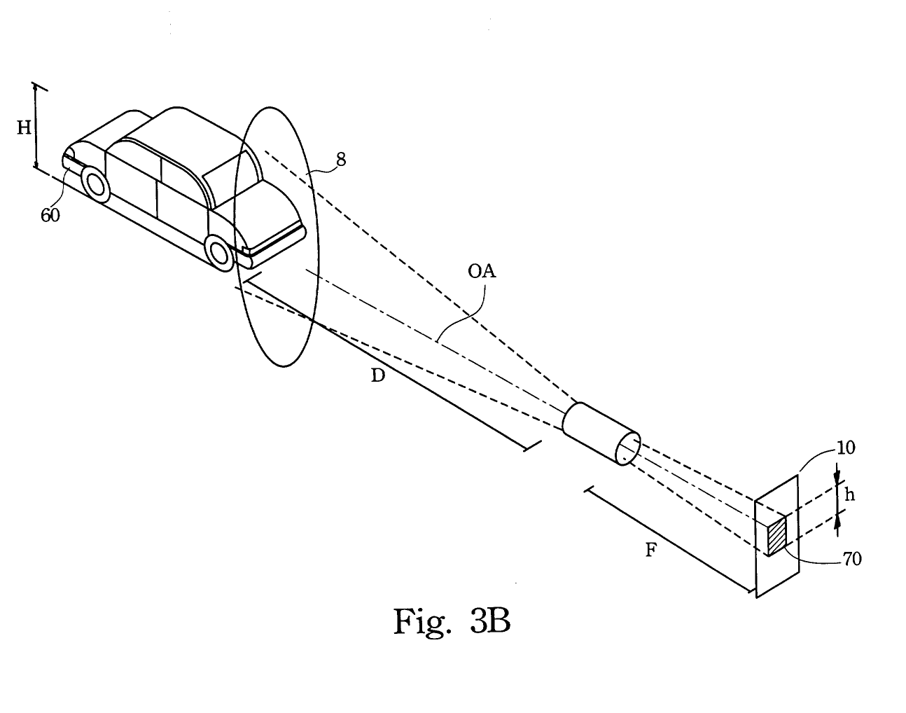

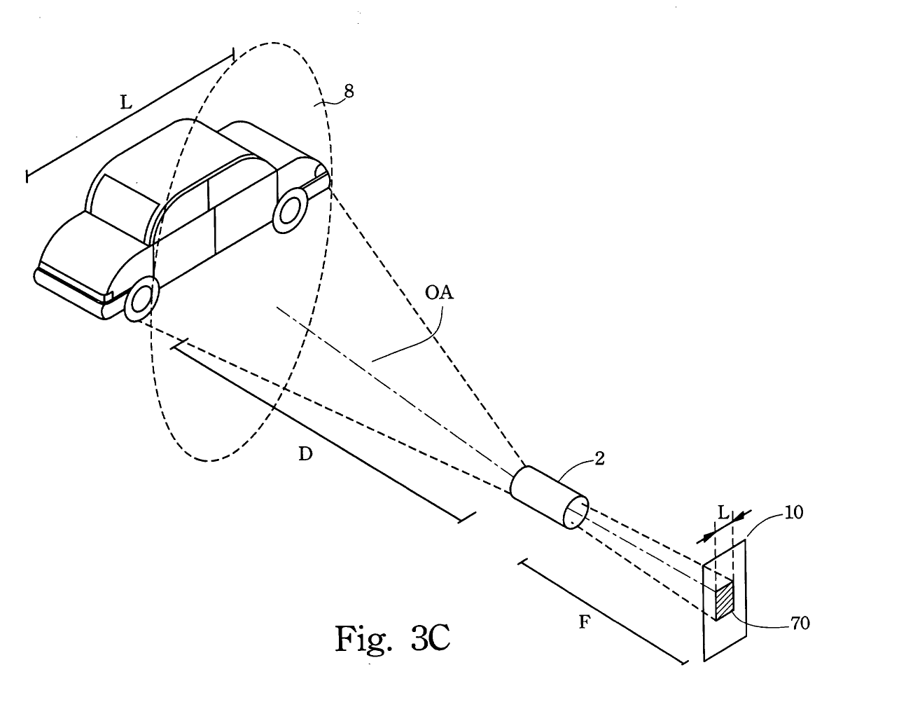

Please refer to FIGS. 3A through 3C. As shown in FIG. 3A, the object 60 is placed at a front focal position D of the zoom lens 2. Therefore, it forms an image 70 at a rear focal position f of the zoom lens 2; that is, the image is formed on the image detector 10. With simultaneous reference to FIGS. 3A and 3B, the object 60 has a height H on the plane S perpendicular to the optical axis OA of the lens 2. Its image on the image detector 10 has a height h, which can be determined from the product of the pixel height and the number of pixels occupied by the image in the corresponding direction on the image detector 10. After the distance D between the camera and the object is obtained by the camera, the height H of the object can be computed by the CPU using the formula H=D×h/f. With reference to FIGS. 3A and 3C, if the object 60 has a width L on the plane D perpendicular to the optical axis OA of the lens 2, it forms an image 70 with a width 1 on the image detector 10. The width 1 can be determined from the product of the pixel width and the number of pixels occupied by the image in the corresponding direction on the image detector 10. After the distance D between the camera and the object is obtained by the camera, the height L of the object can be computed by the CPU using the formula L=D×1/f.

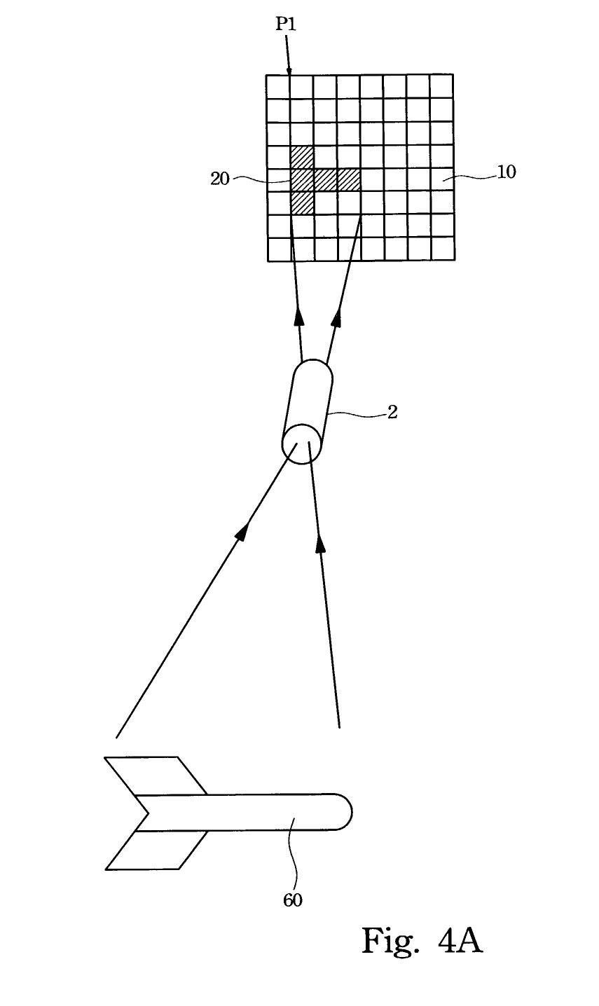

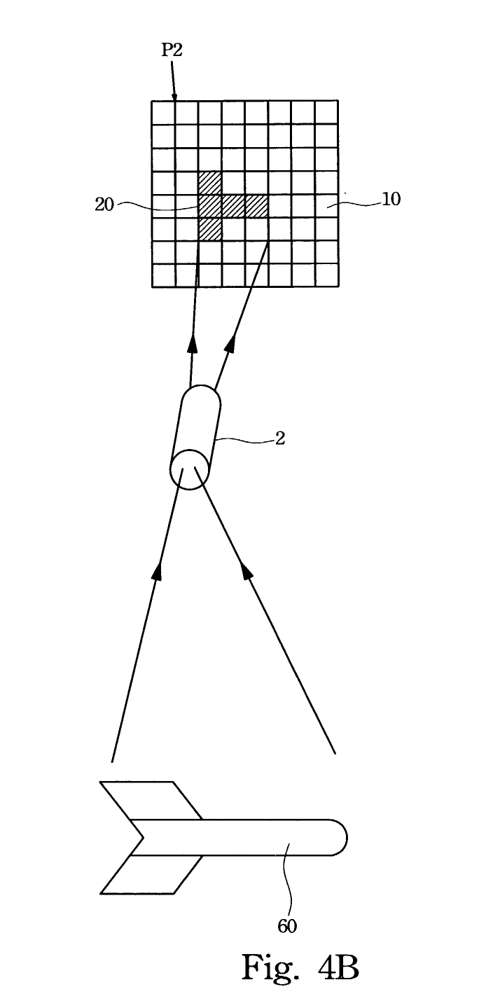

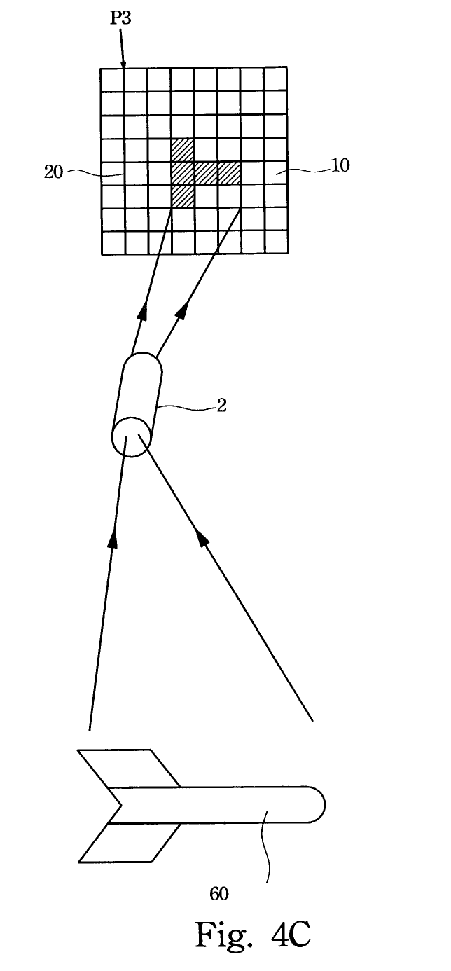

With reference to FIG. 4A, at time t1 the image 70 is formed at a first position p1 on the image detector 10. In FIG. 4B, the image 70 is at a second position p2 at time t2. Thus, the microprocessor computes the speed of the image between time t1 and time t2. When the object 60 moves at an unknown speed V on the plane perpendicular to the optical axis of the lens 2, the image 70 moves at a speed v on the image detector 10. Since the speed v of the image is already obtained by the number of pixels the image 70 crosses divided by the time interval, the CPU further calculates the speed V of the object on the plane S by multiplying the image speed v by the magnification power M of the zoom lens, where M=D/f. In other words, after obtaining the distance between the camera and the object, the camera can further figure out the object speed V.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A camera for measuring the distance to an object, comprising:
a lens, having an optical axis and forming an image for the object;
an image detector, placed at the back focal position of the lens to detect the image and to covert the image into an image signal;
a microprocessor, controlling the image detector to detect the image and processing the image;
an image display, receiving and displaying the image signal from the image detector and the microprocessor;
a laser range-measuring device, controlled by the microprocessor to emit a single-wavelength beam for measuring the distance between the camera and the object; and
a beam splitting device, placed on the optical axis of the lens, wherein the beam splitting device guides the single-wavelength beam to the object and the image to the image detector.

2. The camera for measuring the distance to an object as claimed in claim 1, wherein the laser range-measuring device further comprises:
a light emitter, emitting the single-wavelength beam, wherein the single-wavelength beam passes the lens by the beam splitting device and is incident on the object, and the object reflects the single-wavelength beam; and
a light receiver, receiving the single-wavelength beam reflected from the object and outputing an electric signal;
wherein the microprocessor processes the electric signal to obtain the distance between the camera and the object.

3. The camera for measuring the distance to an object as claimed in claim 2, wherein the microprocessor further comprises:
a range signal processor, processing the electric signal and outputing a range signal;
an image processor, processing the image signal from the image detector; and
a CPU (Central Processing Unit), controlling the light emitter to emit the single-wavelength beam, computing the distance between the camera and the object according to the range signal, and outputting the image signal processed by the image processor to the image display.

4. The camera for measuring the distance to an object as claimed in claim 1 further comprising:
an aperture, controlled by the microprocessor for adjusting the exposure; and
a motor, controlled by the microprocessor for adjusting the focal length of the lens.

5. The camera of claim 1, wherein the image detector is a CCD (Charge-Coupled Device).

6. The camera of claim 2, wherein the light emitter is a semiconductor emitter and the light receiver is an avalanche photodiode receiver.
